(19) United States
(12) Patent Application Publication
(10) Pub. No.: US 2008/0116707 A1
(43) Pub. Date: May 22, 2008

(54) Sealing Assembly

(75) Inventors: Zachary T. Boaz, Streetsboro, OH (US); Jason C. Dennison, Tallmadge, OH (US)

Correspondence Address: CALFEE HALTER & GRISWOLD, LLP, 800 SUPERIOR AVENUE, SUITE 1400, CLEVELAND, OH, 44114, US

(73) Assignee: Mantaline Corporation, Aurora, OH (US)

(21) Appl. No.: 11/562,713

(22) Filed: Nov. 22, 2006

(51) Int. Cl. B60P 3/34

(52) U.S. Cl. 296/26.01

(57) ABSTRACT

The present application discloses several embodiments of sealing assemblies and sealing components. In various embodiments, sealing assemblies are provided which include a frame assembly and at least one sealing component selected from a wiper seal and a bulb seal. In additional embodiments, a bulb seal is provided alone separate from a sealing assembly. In additional embodiments, a wiper seal is provided alone separate from a sealing assembly.

### TECHNICAL FIELD

The present application relates generally to a sealing assembly. In particular embodiments, this application relates to a sealing assembly for use with recreational vehicles that include extensible rooms or compartments, commonly referred to as “slide-outs,” that are adapted to extend from the recreational vehicle to increase the effective interior living space of the vehicle.

### BACKGROUND OF THE INVENTION

Sealing assemblies are useful in a variety of contexts, such as for example, at the interface between a building structure or vehicle and a retractable compartment. An example of such a structure or vehicle is a recreational vehicle. Recreational vehicles (or “RVs”), such as motor homes, travel trailers, fifth wheel trailers, campers, and the like, are widely popular. They can be used for a wide array of recreational activities, such as vacations and camping, or can even be used as full time domiciles. The width of recreational vehicles is limited to that that may be accommodated for travel on public roadways. And as the size of a recreational vehicle is increased, its maneuverability and ease of handling is decreased. Accordingly, retractable compartments in the form of slide-out rooms have become a popular feature in many recreational vehicles. These slide-out rooms can be moved from a retracted position within the vehicle to an extended position so as to effectively expand the useable interior space of the recreational vehicle.

Generally, the interface between a recreational vehicle and a slide-out room often includes gaps or spaces that can allow water, debris, and excessive air drafts to enter the interior of the recreational vehicle from the outside. In addition, if the top or other exterior portion of the slide-out room collects water or debris when it is the extended position, and the slide-out room is then retracted within the recreational vehicle, the water or debris located on the top or other exterior of the slide-out room can enter the interior of the recreational vehicle. Accordingly, for recreational vehicles that include slide-out rooms there is a need for seals or sealing assemblies to prevent wind, moisture or debris from entering the recreational vehicle through the interface between the recreational vehicle and the slide-out room.

### BRIEF DESCRIPTION OF THE DRAWINGS

FIG. 1 is a perspective view of an embodiment of a sealing assembly installed on a recreational vehicle;

FIG. 2 is a perspective cut-away view of the sealing assembly of FIG. 1;

FIG. 3 is an magnified perspective view of a first sealing module of the sealing assembly of FIG. 2;

FIG. 4 is a magnified perspective view of a second sealing module of the sealing assembly of FIG. 2;

FIG. 5 is a cross-sectional view of the first sealing module of the sealing assembly of FIG. 2 installed onto a side wall of a recreational vehicle;

FIG. 6 is a cross-sectional view of the second sealing module of the sealing assembly of FIG. 2 installed onto a side wall of a recreational vehicle;

FIG. 7 is a cross-sectional view of the sealing assembly of FIG. 2 installed onto a side wall of a recreational vehicle and a slide-out room mounted within the sealing assembly;

FIG. 8 is a side view of a wiper arm of the wiper seal of the first sealing module of FIG. 3 wiping against a surface;

FIGS. 9A-9D depict the deformation of a bulb seal of the sealing assembly of FIG. 2 in various stages of deformation;

FIG. 10 is a cross-sectional perspective view of the sealing module of FIG. 4 mounted onto a side wall of a recreational vehicle illustrating the drainage of water through the drainage channel of the frame assembly; and

FIG. 11 is a cutaway perspective view of a corner of the sealing assembly of FIG. 2 illustrating a portion of the frame assembly which has been filled with optional sealing foam.

### DETAILED DESCRIPTION

The present application relates generally to sealing assemblies. In particular embodiments, this application relates to sealing assemblies for use with recreational vehicles that include extensible rooms or compartments that are adapted to extend from the recreational vehicle to increase the effective interior living space of the vehicle. These compartments are commonly referred to as “slide-outs” in the RV trade, and are referred to herein as slide-out rooms. Generally, the sealing assemblies of this application, in various embodiments, are adapted to seal the interface between a structure, such as a recreational vehicle, and a retractable structure or compartment, such as a slide-out room, to prevent the entrance of air, water, or debris into the interior of the structure. Sealing assemblies according to the instant disclosure can be used with slide-out rooms of RVs having varying construction such as conventional slide-out rooms (flush floor slide-out rooms) or drop-down slide-out rooms (non-flush floor slide-out rooms). Sealing assemblies according to the instant disclosure can be used in the context of structures other than RVs, such as conventional or modular construction buildings, or vehicles. By way of example only, sealing assemblies according to this disclosure may be used for retractable or slide-out windows, window seats or rooms in a structure such as a home or office. Accordingly, it will be understood that this application is applicable to and encompasses sealing assemblies of varying construction, and is not limited to use in recreational vehicles.

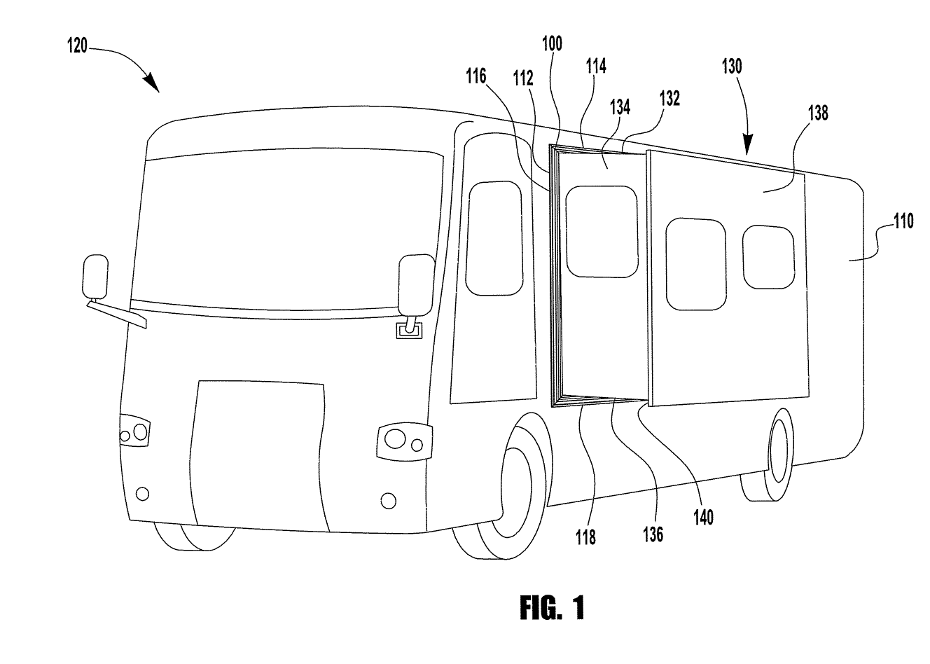

Referring to FIG. 1, a perspective view of one embodiment of a sealing assembly 100 is shown installed into a recreational vehicle 120. The illustrated slide-out room 130 has a generally rectangular cross section with a top wall 132, a pair of side walls 134, a bottom wall 136, a front wall 138, and. The depicted sealing assembly 100 is installed along the perimeter of an opening 112 defined within the side wall 110 of the recreational vehicle 120. The opening 112 has a top 114, two sides 116, and a bottom 118, and is adapted to allow travel of the slide-out room 130 between a retracted position within recreational vehicle 120 and an extended position. In this particular illustrated embodiment, the peripheral flange 140 extends around the periphery of the front wall 138 of the slide-out room 130 such that the area of the front wall 138 is greater than the area of the opening 112, and the flange 140 extends beyond the opening 112 to overlap the side wall 110 of the recreational vehicle. As the slide-out room 130 of the embodiment illustrated in FIG. 1 travels between the retracted and extended positions, the sealing assembly 100 contacts portions of the exterior of the slide-out room 130 to control the entry of air, water and debris, and to provide a seal between the interior and exterior spaces.

It will be understood by those skilled in the art that in alternate embodiments, the sealing assemblies according to this disclosure can be adapted for use with slide-out structures or compartments having a variety of different shapes, configurations, and constructions. In alternate embodiments, sealing assemblies are adapted for use with slide-out compartments or structures that do not include a flange. In yet other embodiments, the sealing assemblies surround only a portion of the perimeter of an opening, such as along only the top, or along only the top and the bottom, or along only the bottom and sides, or in other combinations. In alternate embodiments, a sealing assembly may be mounted onto a portion of the slide-out structure or compartment rather than on to the structure.

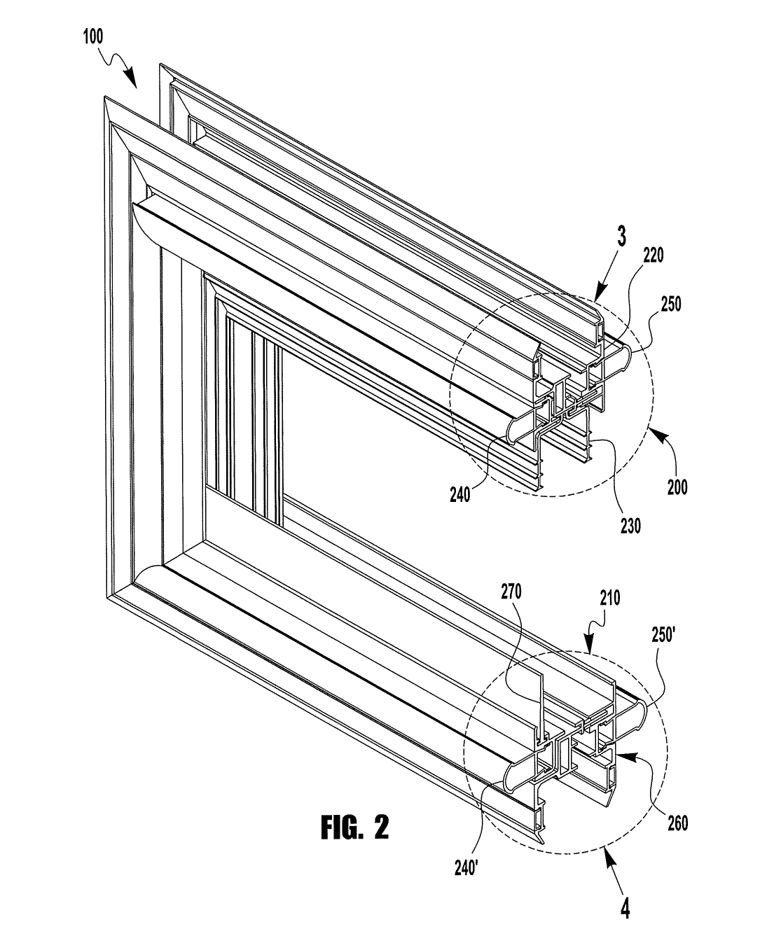

In various embodiments, the sealing assemblies according to the disclosure comprise one, two, three, four, or more sealing modules. Referring to FIG. 2, the depicted embodiment is a rectangular shaped sealing assembly 100 having four sides, and shown in cut-away, to reveal a cross sectional view of two sealing modules 200 and 210, located on the top and bottom, respectively, of the illustrated sealing assembly 100. The modular construction of the depicted sealing assembly 100 allows the sealing assembly 100 to be adapted and sized for use in a variety of combinations of shapes, sizes and sealing components (as further described herein), for use with retractable structures and compartments of varying shapes, constructions and configurations. Of course, in various embodiments, sealing assemblies as provided herein can be formed of a single (i.e., unitary) structure, rather than a combination of two or more modules. In the various embodiments, the sealing assemblies comprise a variety of combinations of sealing components that are further described herein.

In various embodiments, each sealing module or unitary sealing structure according to the disclosure comprises a frame assembly, and at least one sealing component selected from a wiper seal and a bulb seal, and combinations of one or more of these. In one embodiment of a sealing module, as illustrated in FIG. 2, the sealing module 200 comprises a frame assembly 220, a wiper seal 230, an exterior bulb seal 240, and an interior bulb seal 250. The sealing module 200 is mounted to the top 114 of the opening 112 in the side wall 110 of an RV by attachment of the frame assembly 220 to the side wall 110 of the recreational vehicle 120 for supporting additional components of the sealing module 200. As depicted, the wiper seal 230 is adapted to contact the top wall 132 and side walls 134 of the slide-out room 130 to create a resilient seal between the recreational vehicle 120 and the slide-out room 130 and to facilitate removal of water or debris located on the top wall 132, thereby preventing entry of such matter into the recreational vehicle 120. The exterior bulb seal 240 is adapted to create a seal when contacted with the peripheral flange 140 of the slide-out room 130 when the slide-out room 130 is in the retracted position within the recreational vehicle 120. The resulting seal prevents entry of air, water, or debris into the interior of the recreational vehicle 120 around the opening 112. Similarly, the interior bulb seal 250 is adapted to create a seal when contacted with an inner peripheral flange (as shown in FIG. 7) of the slide-out room 130 when the slide-out room 130 is in the extended position. As such, when the slide-out room 130 of the embodiment illustrated in FIG. 1 is in the extended position, the wiper seal 230 acts as the primary weather seal as it is the first barrier to entry into the recreational vehicle encountered by rain, water, wind or the elements and the interior bulb seal 250 acts as the secondary weather seal as it is the second barrier to entry into the recreational vehicle encountered by rain, water, wind or the elements.

In another embodiment of a sealing module, as illustrated in FIG. 2, the sealing module 210, like the sealing module 200, comprises a frame assembly 260, a wiper seal 270, an exterior bulb seal 240′, and an interior bulb seal 250′. The sealing module 210 is mounted to the bottom 118 of the opening 112 in the side wall 110 of an RV by attachment of the frame assembly 260 to the side wall 110 of the recreational vehicle 120 for supporting additional components of the sealing module 210. As depicted, the wiper seal 270 is adapted to contact the bottom wall 136 of the slide-out room 130 to create a resilient seal between the recreational vehicle 120 and the slide-out room 130 and to facilitate removal of water or debris located on the bottom wall 136, thereby preventing entry of such matter into the recreational vehicle 120. The exterior bulb seal 240′ is adapted to create a seal when contacted with the peripheral flange 140 of the slide-out room 130 when the slide-out room 130 is in the retracted position within the recreational vehicle 120. The resulting seal prevents entry of air, water, or debris into the interior of the recreational vehicle 120 around the opening 112. Similarly, the interior bulb seal 250′ is adapted to create a seal when contacted with an inner peripheral flange ((as shown in FIG. 7) of the slide-out room 130 when the slide-out room 130 is in the extended position.

It will be understood based on the foregoing descriptions of the illustrated embodiments of sealing modules, 200 and 210, that when a sealing component of a sealing module, is generally identical to a component of the sealing module 200, the reference numerals are the same except for the presence of a prime designation (′) shown in this detailed description as well as the Figures of this application. It will be understood further that components or features that are included with the sealing module 210 and not the sealing module 200 are given their own unique reference numeral to clearly distinguish the difference between the identified components or features. It will be understood that in some embodiments of sealing assemblies within the scope of the disclosure that two or more sealing modules may be identical, or may not share any common components.

As previously noted, the sealing assembly 100 illustrated in FIG. 2 is an embodiment according to this disclosure that comprises four sealing modules arranged in a rectangular configuration. In this depicted embodiment, each of the modules that are adapted for attachment to the tope and two sides of an opening comprise the same sealing components and frame assembly construction. And the sealing module adapted for attachment to the bottom of an opening has sealing components and a frame assembly construction that differ from those of the other three modules. Accordingly, again referring to FIG. 2, the sealing module 200 (depicted to be attached to the top 114 and sides 116 of the opening 112 shown in FIG. 1) and the sealing module 210 (depicted to be attached to the bottom 118 of the opening 112 shown in FIG. 1) each include different components, such that the sealing module 200 has a different cross-sectional profile as compared to that of the sealing module 210. In additional embodiments of sealing assembly 100, the entire sealing assembly 100 has generally uniform components throughout and a generally uniform cross-sectional profile as a result. Furthermore, in additional embodiments, sealing assembly 100 can have more than two sections each having different cross-sectional profiles. Thus, in alternate embodiments, a sealing assembly may include various combinations of sealing modules that are mounted to various combinations of the top, sides, and bottoms of openings defined within a wall of a structure, or portions thereof, or portions of a slide-out compartment or structure.

It will be understood that a sealing module, and the sealing module along with its sealing components, or any other portion of, or any sealing assembly according to this application can be scaled, sized or configured to be used with any of a variety of recreational vehicles with slide-out rooms, or other moveable compartments in any of a variety of structures, each having various size, shapes, and configurations. In addition, the general shape or configuration of a sealing assembly may vary in alternate embodiments. Thus, while the sealing assembly 100 of the embodiment illustrated in FIG. 1 has a generally rectangular shape, a sealing assembly of an alternate embodiment may have a different shape or configuration. Examples of additional shapes that maybe utilized for a sealing assembly include, but are not limited to, square, circular, triangular, elliptical, irregularly shaped, or the shape of any other polygon. In addition, a sealing assembly need not be in the shape of any geometrical or other form, and maybe a single strip or an arrangement of multiple strips configured in various ways, such as in a contiguous or interrupted line, or in parallel, or in a perpendicular arrangement.

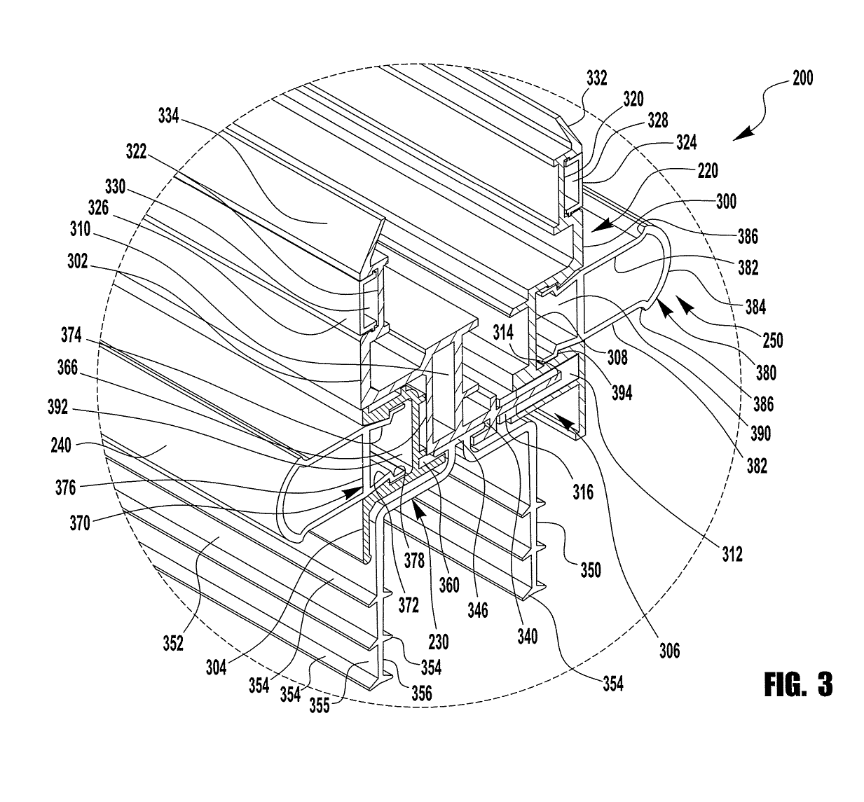

As previously described in connection with the embodiments depicted in FIG. 2, each sealing module 200 includes a frame assembly 220. The frame assembly 220 can take a variety of shapes and configurations. Referring to FIG. 3, the frame assembly 220 of the illustrated in FIG. 2 is of a modular construction and comprises a first frame member 300, second frame member 302, third frame member 304, and adjustable joint 306. The frame assembly 220 of the illustrated embodiment is adapted to be mounted to the side wall 110 of the recreational vehicle 120 with the adjustable joint 306 allowing the frame assembly 220 to be adapted for use with side walls 110, or other structures, of varying thicknesses. Additional embodiments of the frame assembly 220 are provided without adjustable joints 306 and are adapted for use with side walls 110, or other structures, of specific thicknesses. The frame assembly 220 can take any shape or configuration that allows it to be mounted to the side wall 110 and is adapted for the attachment of additional sealing components.

Referring further to FIG. 3, the illustrated frame members 300, 302, and 304 of the frame assembly 220 can be formed from a variety of materials or combinations thereof, including, but not limited to, alumimm, tin, steel, plastics, polymers, fiberglass, wood, or other suitable materials or composites or other combinations thereof. In the embodiment of the sealing module 200 illustrated in FIG. 3, the frame members 300, 302, 304 are constructed of aluminum and are formed through an extrusion process. Alternate embodiments of the frame members 300, 302, 304 may be constructed of other suitable materials or combinations thereof, and formed by one or more of a variety of methods or processes that are known in the art. In some embodiments of the frame assembly 220, the frame members 300, 302, 304 may be formed from one or more materials or combinations thereof.

Frame assemblies according to this application are not limited to three frame members as illustrated in FIG. 3. In alternate embodiments, frame assemblies may include different numbers of frame members. Additionally, the frame assemblies of alternate embodiments need not be constructed modularly, and can be of a unitary, one-piece construction. As with the overall sealing assembly 100, the frame assembly 220, as shown in FIG. 2, may be adapted for use with slide-out rooms 130 of recreational vehicles 120 (or other moveable compartments) of varying construction and may be sized, scaled and shaped accordingly. As such, the construction of the frame assembly 220 that is illustrated in FIG. 3 is not meant to be limiting, as additional embodiments of the frame assembly 220 of the sealing module 200 possess a variety of different dimensions, shapes, constructions and configurations.

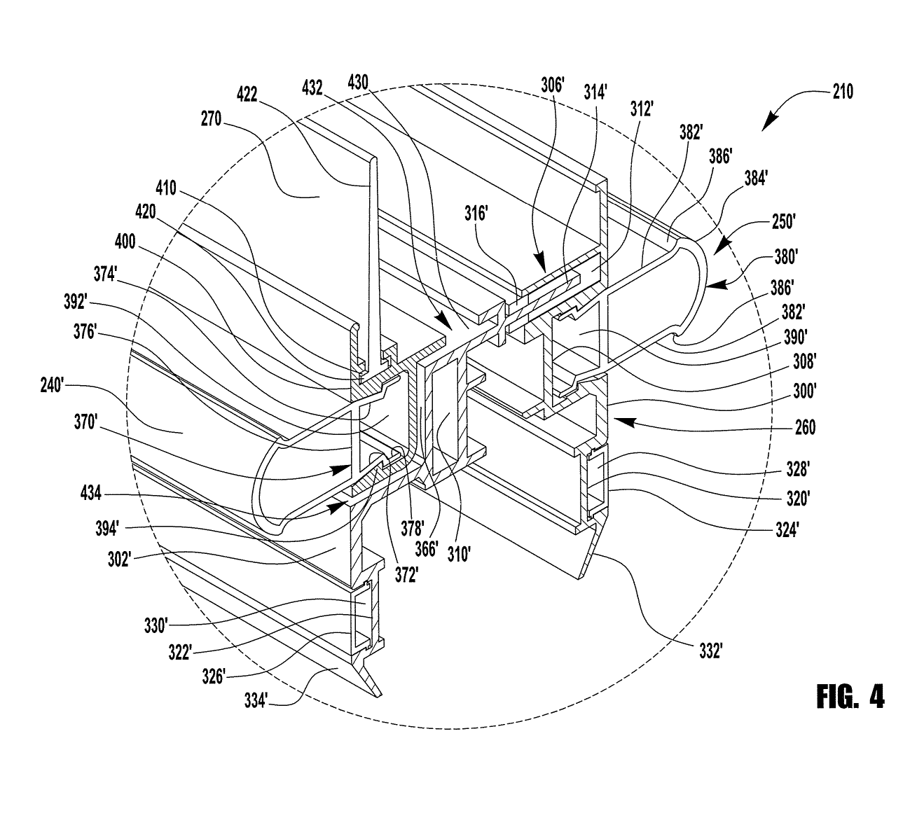

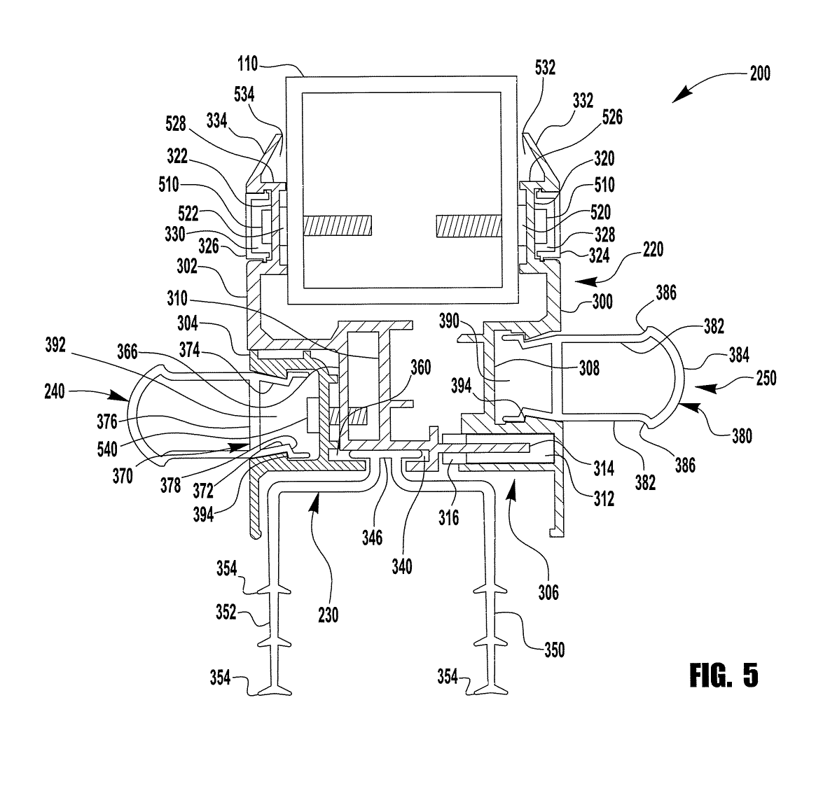

The first frame member 300 and second frame member 302 of the embodiment of the sealing module 200 illustrated in FIGS. 3 and 5 each have a side wall enclosing portions 308, 310. The sidewall enclosing portion 308 of the first frame member 300 and the sidewall enclosing portion 310 of the second frame member 302 have generally complementary shapes. When the first frame member 300 and second frame member 302 of the embodiment of the first frame assembly illustrated in FIG. 3 are abutted against each other, the enclosing portions 308, 310 of the first and second frame members 300, 302 combine to surround and enclose a portion of the side wall 110 as shown in FIG. 5. It will be understood that additional embodiments of the frame assembly 220 of the sealing module 200 include frame members that do not surround and enclose a portion of the side wall 110. Rather, additional embodiments of the frame assembly are adapted to a face of the sidewall and not enclose the sidewall. In addition, further embodiments of the sealing assembly 100 may include separate frame members that independently mount to the interior and exterior of the side wall and do not join together.

Referring again to FIGS. 3 and 5, the illustrated embodiment of the sealing module 200 includes an adjustable joint 306 located between the first frame member 300 and the second frame member 302. This adjustable joint 306 allows sealing module 200 to be used with side walls 110 or other structures of varying thicknesses. The adjustable joint 306 can take many shapes and configurations. The adjustable joint 306 of the embodiment of the sealing module illustrated in FIG. 3 includes a groove 312 defined within a portion of the first frame member 300 that accepts a projection 314 that extends from a portion of the second frame member 302. The receipt of the projections 314 of the second frame member 302 by the groove 312 of the first frame member 300 serves to adjustably join the first frame member 300 and the second frame member 302.

In the embodiment of the adjustable joint 306 illustrated in FIG. 3, the projection 314 is adapted to have a range of travel within the groove 312. Accordingly, the first frame member 300 and second frame member 302 can move inward and outward with respect to each other and still remain interlocked or connected via the engagement of the projection 314 with the groove 312. In this manner, the first frame member 300 and the second frame member 302 can be placed around a side wall or other structure of varying thickness and be adjusted to fit snugly around the particular side wall.

The embodiment of the adjustable joint 306 illustrated in FIG. 3 includes a seal 316 that retains the projection 314 in a desired position relative to the groove 312 until an adequate unsealing force is exerted on the first and second frame members 300, 302. The seal 316 can be made from many materials and can take many shapes and configurations. As illustrated in FIG. 3, the seal 316 is a strip of butyl rubber tape that is inserted into the groove 312 of the first frame member 300 prior to the insertion of the projection 314 of the second frame member. Once the first frame member 300 and second frame member 302 are located in a desired position relative to one another by an assembler of the sealing assembly 100 or other individual, the butyl rubber tape 316 hardens forming a generally waterproof seal between the projection 314 and the groove 312. This seal formed by the butyl rubber tape 316 will retain the first frame member 300 and second frame member 302 in this desired position relative to another until a sufficient unsealing force is exerted on the adjustable joint 306. Examples of additional materials that can be used for the seal 316 include, but are not limited to, any type of polymers, rubbers, caulk, plastic, etc. While the butyl rubber tape of the embodiment of the seal 316 illustrated in FIG. 3 creates a water tight seal, additional embodiments of the adjustable joint 306 do not create a water tight seal. Additional embodiments of the sealing module 300 that include an adjustable joint 306 are provided without a seal 316.

It will be understood that additional embodiments of the sealing module 300 are provided without an adjustable joint 306. In addition, the adjustable joint can be configured differently in additional embodiments of the sealing assembly. For example, the groove 312 maybe located on the second frame member 302 and the projection 314 maybe located on the first frame member 300. In addition, the adjustable joint 306 of this detailed description is not limited to the adjustable joint 306 illustrated in FIG. 3. The adjustable joint 306 may have any shape or configuration that allows the frame members to be adjusted relative to one another. Examples of other types of adjustable joints that can be used with additional embodiments of the sealing assembly 100 include, but are not limited to, any type of telescopic joint, threaded or screw type adjustable joints, clamping type adjustable joints, or other types of adjustable joints.

The embodiments of the first frame member 300 and second frame member 302 illustrated in FIG. 3 each include a mounting portion 320, 322, respectively. The mounting portions 320, 322 can take a variety of shapes and configurations. The mounting portions 320, 322 are utilized in attaching the first frame member 300 and second frame member 302 of the frame assembly 220 to the side wall 110. Referring now to FIG. 5, the mounting portions 320, 322 of the first and second frame members 300, 302 of the illustrated embodiment are attached to the side wall 100 by a plurality of fasteners 510 that pass through a plurality of fastener openings (not shown) defined within the mounting portions 320, 322 and engage the side wall 110. The fasteners 510 of the embodiment of the first and second frame members 300, 302 illustrated in FIG. 5 are conventional screws.

The use of screws for attaching the embodiment of the first and second frame members 300, 302 illustrated in FIG. 5 to the side wall 110 also allows the first and second frame member 300, 302 to be easily removed from the side wall 110 to facilitate the servicing and/or replacement of the first and second frame members 300, 302 or other portions of the sealing module 200. It will be understood, however, that the first frame member 300 and second frame member 302 may be attached to the side wall 110 by any method now or hereafter known in the art. Examples of attachment methods include, but are not limited to, any type of screws, bolts, nails, rivets, welding, epoxy, glue, tape, cotter pins, rings, keys, tabs and slots, adhesives, and pressure fitting methods.

In the embodiment of the sealing module 200 illustrated in FIG. 5, the mounting portions 320, 322 of the first and second frame members 300, 302 are attached snugly against the side wall 110 and include optional seals 520, 522, which help to create a generally waterproof seal between the first and second frame members 300, 302 and the side wall 100. The seals 520, 522 can be formed from a variety of materials and can take a variety of shapes and configurations. In the embodiment of the sealing module 200 illustrated in FIG. 5, the seals 520, 522 are formed from butyl rubber tape that is located between the side wall 100 and the first and second frame members 300, 302 as the mounting portions 320, 322 of the first and second frame members 300, 302 are fastened to the side wall 110. As the mounting portions 320, 322 of the first and second frame members 300, 302 are fastened to the side wall 110, the seals 520, 522 distort to ensure a water tight seal between first frame member 300 and side wall 110. Examples of additional materials that can be used for the seals 520, 522 include, but are not limited, to any type of polymers, rubbers, caulk, plastic, etc. Further, alternate embodiments of the sealing assembly 100 do not include seals 520, 522.

The embodiment of sealing module 200 illustrated in FIGS. 3 and 5 includes fastener covers 324, 326 that snap within the fastener channel 328 defined within the mounting portion 320 of the first frame member 300 and the fastener channel 330 defined within the mounting portion 322 of the second frame member 302. The fastener covers 324, 326 serve to hide and protect the fasteners 510 used to mount the first frame member 300 and second frame member to the side-wall 110 and the sealing module 200 a generally more finished appearance. In addition, the fastener covers 324, 326 shield the fasteners 510 and help to diminish the likelihood of corrosion and other effects that result from exposure to the elements. The fastener covers 324, 326 may be easily removed to allow access to attachment means for easy removal of the frame members 300, 302 dining the replacement and servicing of the sealing assembly 100. The fastener covers 324, 326 may have any shape or configuration that provides for the covering of the fasteners 510. It will be understood that the fastener covers 324, 326 are optional and additional embodiments of the sealing module 200 are provided without fastener covers 324, 326.

In the embodiment of the sealing module 200 illustrated in FIG. 5, the first and second frame members 300, 302 each include a flange 332, 334, respectively. The flanges 332, 334 can take a variety of shapes and configurations. The flanges 332, 334 of the first and second frame members 300, 302 of the embodiment of the sealing module 200 illustrated in FIG. 5 are generally planar walls that extend upward from the mounting portions 320, 322 and are angled in towards the side wall 110. However, the flanges 332, 334 have various orientations in other embodiments. For example, the flanges 332, 334 can be vertically oriented, horizontally oriented, or angled out away from side wall 110. The flanges 332, 334 of the first and second frame members 300, 302 of the embodiment of the sealing module 200 illustrated in FIG. 5 are oriented to provide a gap between the flanges 332, 334 and side-wall 10. However, additional embodiments of the flanges 332, 334 are not oriented to provide a gap between the flanges 332, 334 and the side wall 110. Further still, additional embodiments of sealing module 200 may only include one flange or need not include any flanges 332, 334.

In the embodiment of the sealing module 200 illustrated in FIG. 5, the mounting portions 320, 322 of the first and second frame members 300, 302 each include a top wall 526, 528, respectively, which abuts against the side wall 110. In the embodiment of the sealing module 200 illustrated in FIG. 5, channels 532, 534 are formed between the flanges 332, 334 together with the top walls 526, 528 of the mounting portions 320, 322 and the sidewall 110. The channels 532, 534 can take a variety of shapes and configurations. The channels 532, 534 serve to gather water or condensation that gathers on the sidewall 110; the excess water or condensation flowing down the sidewall 100 and into the channels 532, 534. The channels 532, 534 of the sealing module 200 run along the entire length of the top 114 and sides 116 of the opening 112 defined within the side wall 110. It will be understood that additional embodiments of the sealing assembly 100 include channels that only run along a portion of the opening 112 defined in the side wall 110 or are located on other portions of the sealing assembly 100, the recreational vehicle 120 or the slide-out room 130.

As water collects within the channels 532, 534, it flows within the channels 532, 534 along the top 114 of the opening and down the channels 532, 534 along the sides of the opening. Accordingly, the channels 532, 534 collect rainwater or other excess water and condensation that drips down the sidewall 110 and prevent it from entering the interior of the sealing module 200. The channels 532, 534 can have any shape or configuration that provides for the collection of water or other fluid. Additional embodiments of the sealing module 200 are provided without channels 532, 534.

As shown in FIGS. 3 and 5, the illustrated embodiment of the second frame member 302 includes a wiper seal receiving channel 340. The wiper seal receiving channel 340 can take a variety of shapes and configurations. The wiper seal receiving channel 340 of the embodiment of the second frame member is a slot defined within a portion of the sidewall enclosing portion 310 of the second frame member 302. The wiper seal receiving channel 340 can have any shape or configuration that provides for the receipt of a portion of the wiper seal 230. In alternative embodiments of the sealing module 200, the wiper seal receiving channel 340 can be located on the first frame member 300 or other portion of the firs sealing module 200.

As mentioned previously, the sealing module 200 includes a wiper seal 230. The wiper seal 230 can take a wide variety of shapes and configurations. In the embodiment of the wiper seal 230 illustrated in FIGS. 3 and 5 the wiper seal 230 comprises a mounting portion 346, and a pair of wiper arms 350, 352. The mounting portion 346 of the wiper seal 230 can take a variety of shapes and configurations. The mounting portion 346 of the embodiment of the wiper seal illustrated in FIG. 3 is a generally planar tab. The mounting portion 346 of the wiper seal may have many other shapes in additional embodiments. For example, the mounting portion 346 may have a generally circular, triangular, square or other cross-sectional shape. The wiper seal 230 of the embodiment illustrated in FIG. 3 is formed out of a thermoplastic elastomer. Examples of additional materials that can be used for the wiper seal 230 include, but are not limited to, any type of natural or synthetic rubber, such as natural or synthetic polyisoprene, butadiene, ethylene-propylene-diene rubber, neoprene or blends thereof.

The embodiment of the wiper seal 230 illustrated in FIG. 3 has a generally “U” shaped cross section when viewed from the side, i.e. as seen in FIG. 5, with the pair of wiper arms 350, 352 projecting outward from the mounting portion 346 of the wiper seal 230. Additional embodiments of the wiper seal 230 maybe shaped or configured differently. For example, additional embodiments of the wiper seal can have a generally “Y” or “V” shaped cross section when viewed from the side. While the embodiment of the wiper seal 230 illustrated in FIG. 3 includes a pair of wiper arms 350, 352, additional embodiments of the wiper seal 230 are not limited to two arms and may have one or any number of wiper arms.

Each of the wiper arms 350, 352 of the embodiment of the wiper seal 230 illustrated in FIG. 3 include at least one fin 354. The fins 354 can take a wide variety of shapes and configurations. The fins 354 of the embodiment of the wiper seal 230 illustrated in FIG. 3 have a generally triangular cross-section. However, it should be understood that the fins 354 are not limited to this shape and the fins of additional embodiments can have many different shapes. Examples of cross-sectional shapes that can be used for the fins include, but are not limited to, rectangular, semicircular, planar, etc. While each of the wiper arms 350, 352 of the embodiment of the wiper seal 230 illustrated in FIG. 3 include three pairs of fins 354, additional embodiments of the wiper seal can include various number of fins. The wiper arms 350, 352 of the embodiment of the wiper seal 230 illustrated in FIG. 3 each have a forward face 355 and a rearward face 356. While the wiper arms 350, 352 of the embodiment of the wiper seal illustrated in FIG. 3 have fins which project from the wiper arms 350, 352 in a generally perpendicular orientation and which are located on both the forward face 355 and rearward face 336 of each wiper arm 350, 352, additional embodiment of the wiper seal can include fins located on various portions of the wiper arms 350, 352 which project from the wiper arms 350, 352 at a variety of angular orientations. The fins 354 of various embodiments of the wiper seal 230 can be located on one of the forward or rearward face 355, 356 of each of the wiper arms 350, 352 or on both sides.

The wiper arms 350, 352 of the embodiment of the wiper seal 230 illustrated in FIG. 3 are adapted to contact the top wall 132 and side walls 134 of the slide-out room 130 and remain in contact with the top wall 132 and side walls 134 whether the slide-out room 130 is stationary or moving relative to the side wall 110 of the recreational vehicle 130. The wiper seal 230 provides a resilient seal between the slide-out room 130 and the sealing module 200 when the slide-out room 130 is stationary with respect to the recreational vehicle. This resilient seal formed between the sealing module 200 and the slide-out room 130 helps to prevent air drafts, rain, snow, debris or other matter from entering the interior of the recreational vehicle through the interface between the recreational vehicle 120 and the slide-out room 130. The resilient seal formed by wiper blade 230 also helps to ensure that cool air or heated air that is intended to stay in the interior of the recreational vehicle does not escape through the interface between the recreational vehicle 120 and the slide-out room 130 as well.

As the slide-out room 130 is moved relative to the side wall 110 of the recreational vehicle, either inwardly or outwardly, the embodiment of the wiper seal 230 illustrated in FIG. 3 remains in contact with the top wall 132 and side walls 134 of the slide-out room 130 and maintains a resilient seal between the sealing module 200 and the slide-out room 130. In addition to maintaining a resilient seal that prevents the entrance of air drafts, rain, snow, leaves, debris or other matter into the interior of the recreational vehicle 120 and prevents the escape of air from the interior of the recreational vehicle 120, the wiper seal 230 also serves to wipe away any excess water, leaves, insects, debris, or other matter that is located on the top wall 132 or side walls 134 of the slide-out room 130 and prevent such matter from entering the interior of the recreational vehicle 120.

Many conventional wiper seals include only one wiper arm. The embodiment of the wiper seal 230 illustrated in FIG. 3 includes a pair of wiper arms 350, 352 to increase the overall surface area of the wiper seal 230 that is contacting the slide-out room 130 and thereby increase the effectiveness of the wiper seal 230 in both forming a resilient seal with the slide-out room 130 and in wiping away excess water, leaves, insects, debris, or other matter located on the slide-out room 130. However, it will be understood that the wiper seal 230 of the present application is not limited to a pair of wiper arms, as additional embodiment of the wiper seal 230 of the present application can include one, two, or any number of wiper arms.

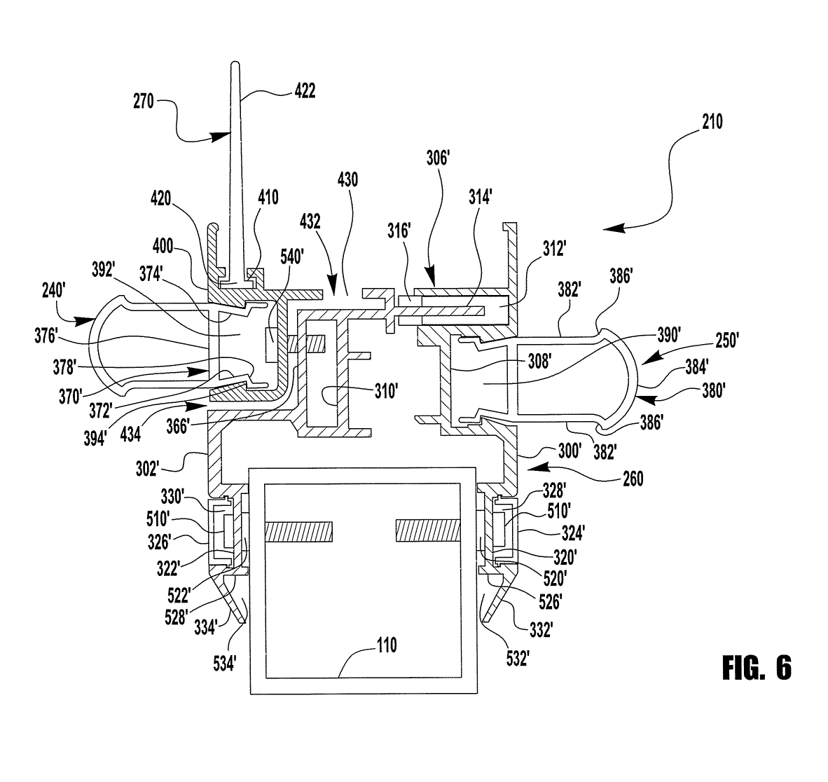

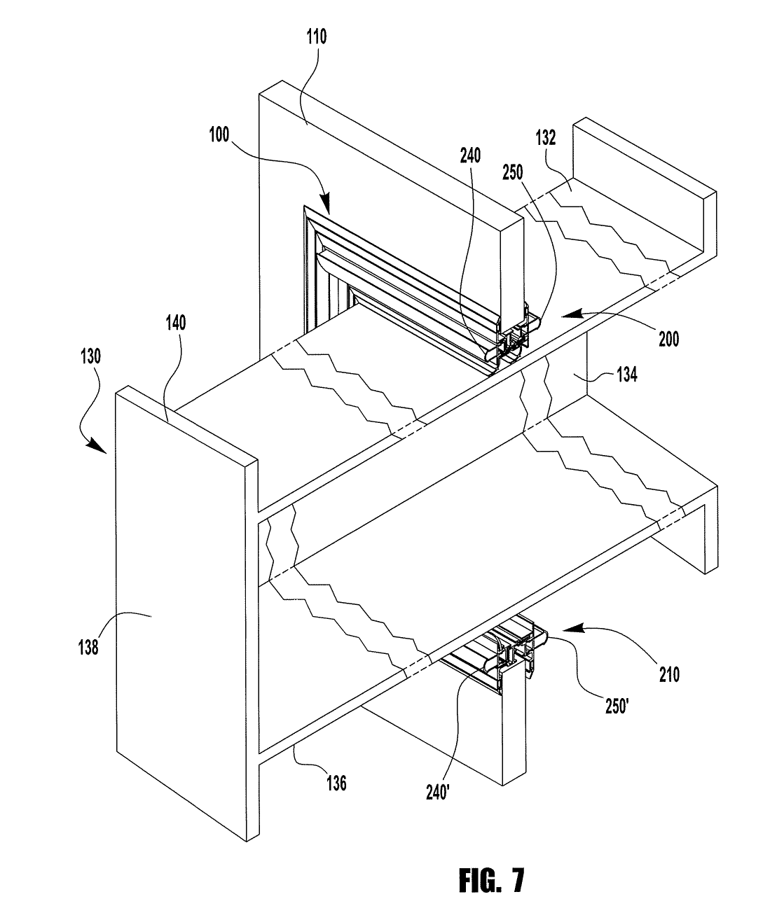

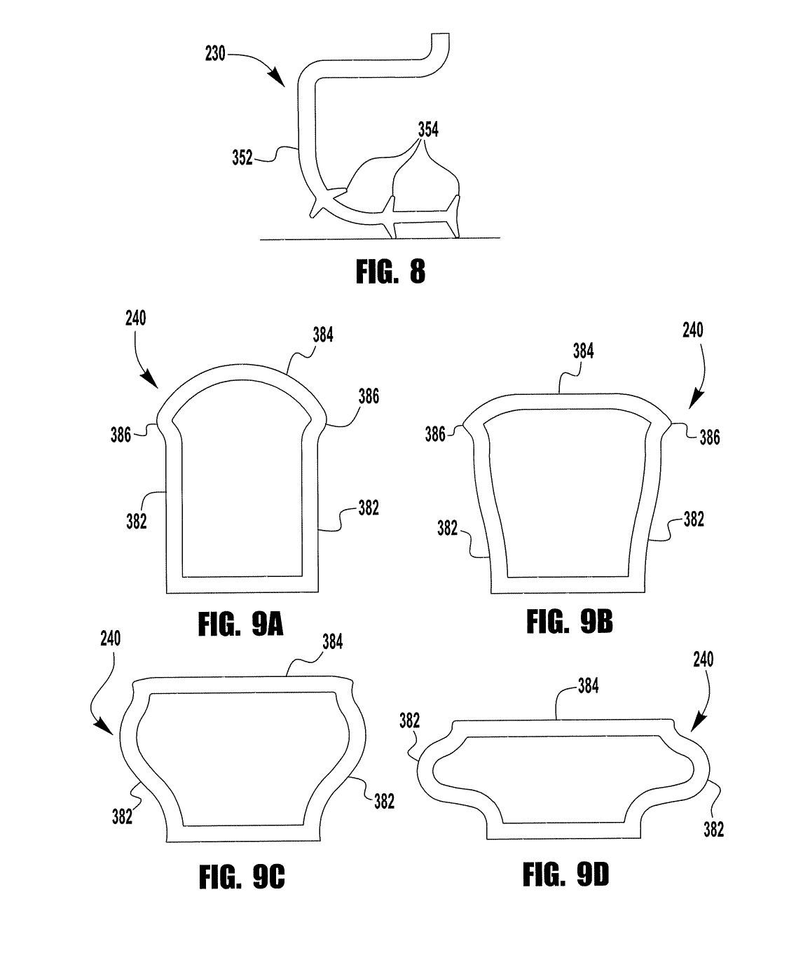

As the slide-out room 130 is moved either outwardly away from the side wall 110 or inwardly towards the side wall 110, the wiper arms 350, 353 contact the surface of the slide-out room 130. The wiper arms 350, 352 of the embodiment of the wiper seal 230 illustrated in FIG. 3 are adapted to deflect when they contact the surface of the slide-out room 130 so the fins 354 of the wiper arms 350, 352 contact the surface of the slide-out room at a generally perpendicular orientation as shown in FIG. 8. As only the tips of the fins 354 of the wiper arms 350, 352 are in contact with the slide out room 130, the area of the wiper arms 350, 352 of the embodiment illustrated in FIG. 3 which contacts the surface of the slide-out room 130 is less than the surface are of the wiper arms 350, 352 which would contact the surface of the slide-out room 130 if the wiper arms 350, 352 were provided without fins 354. Accordingly, the optional fins 354 of the embodiment of the wiper seal 230 illustrated in FIG. 3 help to increase the effectiveness of the wiper arms 350, 352 by decreasing the overall surface area of the wiper seal 230 that contacts the slide-out room 130 thereby increasing the point load contact force of the wiper arms 350, 352 against the slide-out room 130.

The fins 354 of the wiper arms 350, 352 of the embodiment of the wiper seal 230 illustrated in FIG. 3 serve to squeegee or scrape away debris, water, or other liquid present on the surface of the slide-out room 130. The wiper arms 350, 352 of the embodiment of the wiper seal 230 illustrated in FIG. 3 include three pairs of fins 354. The wiper seal 230 of the embodiment illustrated in FIG. 3 is adapted so that at least two of the fins 354 contact the surface of the slide-out room 130 when the slide-out room is moved either outwardly away from the side wall 110 or inwardly towards the side wall 110. However, it should be understood that additional embodiments of the wiper seal 230 may include one, two, or more fins 354 which contact the surface of the slide-out room 130.

The optional fins 354 also help to ensure that the wiper arms 350, 352 are properly oriented with respect to the slide-out room 130. Due to the fact that the fins 354 increase the point load contact force of the wiper arms 350, 352 of the wiper seal 230 against the surface of the slide-out room 130, the frictional force between the wiper arms 350, 352 and the surface of the slide-out room 130 is also increased. This increased frictional force helps to ensure that the wiper arms 350, 352 are properly oriented relative to the slide-out room and do not become folded over or bunch up. As the slide-out room 130 is moved inwardly towards the side wall 110, the forward face 355 of the embodiment of the wiper seal 230 illustrated in FIG. 3 is adapted to contact the surface of the slide-out room 130. As the slide-out room 130 changes directions and is moved outwardly relative to the side wall 110, the rearward face 356 of the embodiment of the wiper seal 230 illustrated in FIG. 3 is adapted to contact the surface of the slide-out room 130. The increased frictional force created by the fins 354 against the slide-out room 130 helps to ensure that the wiper seal 230 flips over when the direction of the movement of the slide-out room 130 is changed. In addition, the wiper arms 350, 352, the fins 354 or other portions of the wiper seal 230 could be coated with an optional material to increase their coefficient of friction. However, it should be understood that wiper seals of various embodiments of the sealing assembly are provided without any such coating.

The frame assembly 220 of the sealing module 220 includes a third frame member 304. The third frame member 304 can take a wide variety of shape and configurations. In the embodiment of the third frame member 304 illustrated in FIG. 3, the third frame member 304 has a generally rectangular cross section when viewed from the side, i.e. as shown in FIG. 5. The third frame member 304 can have any shape or configuration that provides for the mounting of the third frame member 304 to the frame assembly 220 or another portion of the sealing module 200 and provides an attachment point for the mounting of additional components of the sealing module 200. As shown in FIGS. 3 and 5, the illustrated embodiment of the third frame member 304 includes a wiper seal receiving channel 360. The wiper seal receiving channel 360 can take a variety of shapes and configurations. The wiper seal receiving channel 360 of the embodiment of the second frame member is a slot defined within a portion of the third frame member 304. The wiper seal receiving channel 360 can have any shape or configuration that provides for the receipt of a portion of the wiper seal 230. It will be understood that all embodiments of the sealing module 200 do not include a third frame member 304. In additional embodiments of the seal assembly 100 the structure of the third frame member 304 is incorporated into the second frame member 302.

In the embodiment of the sealing module 220 illustrated in FIG. 3, the second frame member 302 includes a frame receiving recess 366 for utilization as a platform in mounting the third frame member 304. The frame receiving recess 366 of the second frame member 302 can take a variety of shapes and configurations. In the embodiment of the second frame member illustrated in Referring now to FIG. 5, the third frame member 304 is mounted to the second frame member 302 by a plurality of fasteners 540 that pass through a plurality of fastener openings (not shown) defined within the third frame member 304 and engage with the second frame member 302. The fasteners 540 of the embodiment of the sealing module 200 are conventional screws. It will be understood, however, that the third frame member 304 may be attached to the second frame member 302 by any method now or hereafter known in the art. Examples of attachment methods include, but are not limited to, any type of screws, bolts, nails, rivets, welding, epoxy, glue, tape, cotter pins, rings, keys, tabs and slots, adhesives, and pressure fitting methods.

Prior to fastening the third frame member 304 of the embodiment of the sealing module illustrated in FIGS. 3 and 5, a portion of the mounting portion 346 of the wiper seal 230 is fit within the wiper seal receiving channel 340 of the second frame member 302. As the third frame member is mounted to the second frame member 302 via fasteners 540, the wiper seal receiving channel 360 of the third frame member 304 is aligned to receive a portion of the mounting portion 346 of the wiper seal 230. The wiper seal receiving channel 340 of the second frame member 302 and the wiper seal receiving channel 360 of the third frame member of the embodiment of the sealing module illustrated in FIG. 5 have complementary shapes, each adapted to receive a separate portion of the mounting portion 346 of the wiper seal 230. Accordingly, the mounting of the third frame member 304 to the second frame member 302 retains the wiper seal 230 onto the frame assembly 220.

The wiper seal 230 of additional embodiments of the sealing assembly 100 are mounted in different ways. For example, the wiper seal receiving channel maybe defined in only one frame member as opposed to being defined within two frame members. As mentioned previously, additional embodiments of the seal assembly 100 do not include a third frame member 304 as the structure of the third frame member 304 is incorporated into the second frame member 302. Accordingly, the wiper seal receiving channels of such embodiment maybe defined solely in the second frame member 302 or the first frame member 300. The wiper seal 230 maybe permanently or non-permanently mounted to the frame assembly 220 or other portion of the sealing module 200 via any type of fasteners, including, but not limited to, screws, bolts, nails, rivets, epoxy, glue, tape, cotter pins, rings, keys, tabs and slots, adhesives, and pressure fitting methods. The wiper seal 230 may also be mounted to the frame assembly 220 or other portion of the sealing module 200 by being slid within a channel adapted to received a portion of the wiper seal 230.

The use of screws for attaching the embodiment of the third frame member 304 to the second frame member 302 illustrated in FIG. 5 allows the third frame member 304 to be easily removed from the second frame member 302 to facilitate the servicing and/or replacement of the third frame member 304, the wiper seal 230 or other portions of the sealing module 200. Once the third frame member 304 is disassembled from the second frame member 302, the wiper seal 230 can be removed from the frame assembly 220. This allows the wiper seal 230 to be removed from the sealing assembly 100 without removing the first frame member 300 or second frame member 320 from the sidewall 110 or disassembling any other component of the sealing assembly 100. As the wiper seal 230 is one of the components of the sealing assembly 100 that experiences the most wear and needs to be replaced the most often, the ease with that it can be removed from the frame assembly 100 and cleaned, serviced, or replaced with a new wiper seal 230 is beneficial to a user of the sealing assembly 100.

The sealing module 200 of the embodiment of the sealing assembly 100 illustrated in FIG. 2 includes an exterior bulb seal 240, and an interior bulb seal 250. The bulb seals of the embodiment illustrated in FIG. 2 each have a similar construction. In additional embodiments of the sealing assembly 100, the bulb seals 240 and 250 may each have a different construction than the other. The bulb seals 240, 250 can take a wide variety of different shapes and configurations. As the bulb seals 240 and 250 of the embodiment of the firs sealing module illustrated in FIG. 3 are constructed in a generally identical fashion, only exterior bulb seal 240 will be discussed with the understanding that interior bulb seal 250 possesses a similar structure.

The bulb seal 240 has a mounting portion 370. The mounting portion 370 can take a wide variety of shapes and configurations. In the embodiment of the sealing module 200 illustrated in FIG. 3, the mounting portion 370 includes a pair of legs 372, 374 that extend from a base wall 376. Each of the legs 372, 374 of the mounting portion 370 of the embodiment of the bulb seal 240 illustrated in FIG. 3 has a locking notch 378. Additional embodiments need not include such a locking notches 378. Also, additional embodiments may include locking mechanisms that are shaped or configured differently than the locking notches 378 of the embodiment of the bulb seal 240 illustrated in FIG. 3. It will be understood that the mounting portions 370 of additional embodiments of the bulb seal 240 maybe shaped and configured differently. The mounting portion 370 of the bulb seal can have any shape or configuration that provides for the mounting of the bulb seal 240 to a portion of the sealing assembly 100.

The bulb seal 240 has a sealing portion 380. The sealing portion 380 can take a variety of different shapes and configurations. The embodiment of the bulb seal 380 illustrated in FIG. 3 has a general “D” shape when viewed from the side, i.e. as illustrated in FIG. 5, with a pair of generally parallel side walls 382 and a curved or arcuate front face 384. The curved front face 384 includes shoulders 386 which extend outwardly beyond the side walls 382. The sealing portion 380 of the bulb seal 240 maybe shaped or configured differently in additional embodiments of the sealing assembly 100. Examples of additional types of seals that maybe used for the bulb seal include, but are not limited, to any type of rubber or silicone tubing or cord, “e” shaped seals, “p” shaped seals, U-channel seals, lip seals, or hollow extrusions of any kind.

The first frame member 300 and third frame member 304 each include a bulb seal receiving recess 390, 392, respectively. The bulb seal receiving recesses 390, 392 can take a wide variety of shapes and configurations. In the embodiment of the sealing module 100 illustrated in FIG. 3, have a generally rectangular cross section when viewed from the side, i.e. as illustrated in FIG. 5. Additional embodiments of the sealing module 100 include bulb seal receiving recesses 390, 392 that are shaped differently. The bulb seal receiving recesses 390, 392 include locking notches 394. Additional embodiments need not include such locking notches 394. Also, additional embodiments may include locking mechanisms that are shaped or configured differently than the locking notches 394 of the embodiment illustrated in FIG. 3.

The bulb seals 240, 250 of the embodiment of the sealing module illustrated in FIG. 3 are mounted to the first frame member 300 and the third frame member 304 by inserting the legs 372, 374 of the mounting portions 370 of the bulb seals 240, 250 into the bulb seal receiving recesses 390, 392. The legs 372, 374 of the embodiment of the bulb seals 240, 250 illustrated in FIG. 3 flex inward when a compressive force is exerted on them. This allows the mounting portion 370 of the bulb seals 240, 250 to be inserted into the bulb seal receiving recesses 390, 392. The locking notches 378 of the bulb seals 240, 250 engage with the locking notches 394 of the bulb seal receiving recesses 390, 392 to retain the bulb seals 240, 250 within bulb seal receiving recesses 390, 392 until a sufficient unlocking force is exerted on the bulb seals 240, 250. This method of mounting the bulb seals 240, 250 to the frame assembly 220 provides for the easy removal of the bulb seals 240, 250 from the frame assembly 220 to facilitate the servicing and/or replacement of the bulb seals 240, 250.

The bulb seals 240, 250 maybe attached to the frame assembly 220 or other portion of the sealing module 200 in a variety of additional ways. The bulb seals 240, 250 maybe permanently or non-permanently mounted to the frame assembly 220 or other portion of the sealing module 200 via any type of fasteners, including, but not limited to, screws, bolts, nails, rivets, epoxy, glue, tape, cotter pins, rings, keys, tabs and slots, adhesives, and pressure fitting methods. The bulb seals 240, 250 may also be mounted to the frame assembly 220 or other portion of the sealing module 200 by being slid within a channel adapted to received a portion of the bulb seals 240, 250.

As mentioned previously, all embodiments of the sealing module 200 need not include a third frame member 304. Accordingly, the bulb seals 240, 250 are attached to the second frame member 302 in additional embodiments. It should also be understood that all embodiments of the sealing module do not include two bulb seals—an interior bulb seal 240 and an exterior bulb seal 250. Additional embodiments of the sealing module can be provided with just one bulb seal or any number of bulb seals. The bulb seals bulb seals 240, 250 can also be mounted to the sidewall 110 of the recreational vehicle 120 or the slide-out room 130 in additional embodiments.

The exterior bulb seals 240 is adapted to contact the flange 140 extending from the slide-out room 130 of the recreational vehicle 120, when the slide-out room is in the retracted position. As the flange 140 contacts the bulb seal 240, the bulb seal 240 is deformed and forms a seal between the sealing assembly 200 and the slide-out room 130 that helps to prevent air drafts, rain, snow, debris or other matter from entering the interior of the recreational vehicle through the interface between the recreational vehicle 120 and the slide-out room 130. The seal formed by exterior bulb seals 240 also helps to ensure that cool air or heated air that is intended to stay in the interior of the recreational vehicle does not escape through the interface between the recreational vehicle 120 and the slide-out room 130 as well.

Similarly, the interior bulb seals 250 is adapted to contact an interior flange (as shown in FIG. 7) of the slide-out room 130 of the recreational vehicle 120, when the slide-out room is in the extended position. As the interior flange contacts the bulb seal 250, the bulb seal 250 is deformed and forms a seal between the sealing assembly 200 and the slide-out room 130 that helps to prevent air drafts, rain, snow, debris or other matter from entering the interior of the recreational vehicle through the interface between the recreational vehicle 120 and the slide-out room 130. The seal formed by interior bulb seals 250 also helps to ensure that cool air or heated air that is intended to stay in the interior of the recreational vehicle does not escape through the interface between the recreational vehicle 120 and the slide-out room 130 as well.

The shape of the bulb seals 240, 250 of the embodiment of the sealing assembly illustrated in FIG. 2 helps to ensure that an effective seal if formed between the bulb seals 240, 250 and the slide-out room 130. As the interior or exterior flange of the slide-out room 130 contacts the bulb seal 240, 250, the curved front face 384 of the bulb seal 240, 250 begins to deform and flatten out as shown by the view of the bulb seal illustrated in FIG. 9B. The shoulders 386 formed by the extension of the curved front face 384 beyond the side walls 382 resist the compressive force exerted on the bulb seals 240, 250 and the flattening of the curved front face 384. This resistive force exerted by the shoulders 386 helps to increase the sealing force exerted by the bulb seals 240, 250 against the interior or exterior flanges of the slide out room. As the pressure exerted on the bulb seals 240, 250 by the interior or exterior flange of the slide-out room 130 increases, the curved front face 384 of the bulb seal 240, 250 flattens out entirely as shown view of the bulb seal illustrated in FIG. 9C. As the pressure exerted on the bulb seals 240, 250 by the interior or exterior flange of the slide-out room 130 continues to increase, the side walls 382 of the bulb seals begin to bow outward as shown by the view of the bulb seal illustrated in FIG. 9D. It should be understood by those skilled in the art that the sealing assembly 100 of this application is not limited to bulb seals having the described shape, configuration, or deformation characteristics described above and that bulb seals having different shapes and configurations can be used in additional embodiments of the sealing assembly 100. Also, it should be understood by those skilled in the art that the bulb seal described herein can be used apart from the sealing assembly 100 and could be used alone or in combination with other components to create a seal against any surface.

As stated above, the wiper seal(s) 230 and the bulb seals( ) 240, 250 of the embodiment illustrated in FIG. 2 are formed out of a thermoplastic elastomer. Examples of additional materials that can be used for the wiper seal(s) 230 and the bulb seals 240, 250 include, but are not limited to, any type of natural or synthetic rubber, such as natural or synthetic polyisoprene, butadiene, ethylene-propylene-diene rubber, neoprene or blends thereof. Various embodiments of the sealing assembly 100 include a wiper seal(s) 230 and/or bulb seal(s) 240, 250 which are formed from more than one section, each of the sections being formed from a material possessing certain material properties. In some embodiments of the sealing assembly 100, a portion of the wiper seal(s) 230 and/or bulb seals 240, 250 are formed from a material having different material properties than the material which is used for the remainder of the wiper seal(s) 230 and/or bulb seals 240, 250. The materials used for various portions of the wiper seal(s) 230 and/or bulb seals 240, 250 can be modified and adapted to obtain wiper seal(s) or bulb seal(s) or portions of the wiper seal(s) 230 and/or bulb seals 240, 250 which possess desired physical characteristic. For example, the material used for the wiper arms 350, 352 or a portion of the wiper arms 350, 352 (or the side walls 382 and front face 384 of the bulb seal(s) 240, 250) may be adapted to achieve a desired flexibility to allow for effective wiping and/or sealing against the slide out room 110 or another surface. In addition, the material used for the mounting portion 346 or other portion of the wiper seal(s) 230 or the mounting portion 370 or other portion of the bulb seal(s) 240, 250 may be adapted to produce a mounting portion 346 and/or 370 which has a desired stiffness to allow for easy installation of the wiper seal(s) 230 and/or bulb seal(s) 240, 250.

To achieve the desired flexibility, the wiper arms 350, 352 or a portion of the wiper arms of the wiper seal 230 (and/or the side walls 382 and front face 384 of the bulb seal(s) 240, 250) of the sealing assembly illustrated in FIG. 3 are formed from a thermoplastic elastomer having a hardness (durometer), a tensile strength, a modulus of elasticity, and a compression set. The thermoplastic elastomer used to form the wiper arms 350, 352 or a portion of the wiper arms of the wiper seal 230 (and/or the side walls 382 and front face 384 of the bulb seal(s) 240, 250) of the sealing assembly illustrated in FIG. 3 has a hardness (durometer) that is generally between 45 Shore A and 65 Shore A but is preferably between 50 Shore A and 60 Shore A. However, it should be apparent to one skilled in the art that materials having other hardness (durometer) values could be used and the present invention is not limited to this expressed range of hardnesses (durometer). A wiper arms 350, 352 or a portion of the wiper arms of the wiper seal 230 (and/or the side walls 382 and front face 384 of the bulb seal(s) 240, 250) of the of the sealing assembly illustrated in FIG. 3 are formed from a material having a hardness (durometer) of 55 Shore A.

The thermoplastic elastomer used to form wiper arms 350, 352 or a portion of the wiper arms of the wiper seal 230 (and/or the side walls 382 and front face 384 of the bulb seal(s) 240, 250) of the sealing assembly illustrated in FIG. 3 has a tensile strength that is generally between 450 psi and 650 psi but is preferably between 500 psi and 600 psi. However, it should be apparent to one skilled in the art that materials having other tensile strength values could be used and the present invention is not limited to this expressed range of tensile strength. A portion of the wiper arms 350, 352 or a portion of the wiper arms of the wiper seal 230 (and/or the side walls 382 and front face 384 of the bulb seal(s) 240, 250) of the sealing assembly illustrated in FIG. 3 are formed from a material having a tensile strength of 547 psi.

The thermoplastic elastomer used to form the wiper arms 350, 352 or a portion of the wiper arms of the wiper seal 230 (and/or the side walls 382 and front face 384 of the bulb seal(s) 240, 250) of the sealing assembly illustrated in FIG. 3 has a modulus of elasticity at 100% strain that is generally between 150 psi and 300 psi but is preferably between 200 psi and 250 psi. However, it should be apparent to one skilled in the art that materials having other modulus of elasticity at 100% strain values could be used and the present invention is not limited to this expressed range of modulus of elasticity at 100% strain. A portion of the wiper arms 350, 352 or a portion of the wiper arms of the wiper seal 230 (and/or the side walls 382 and front face 384 of the bulb seal(s) 240, 250) of the sealing assembly illustrated in FIG. 3 are formed from a material having a modulus of elasticity at 100% strain of 227 psi.

The thermoplastic elastomer used to form the wiper arms 350, 352 or a portion of the wiper arms of the wiper seal 230 (and/or the side walls 382 and front face 384 of the bulb seal(s) 240, 250) of the sealing assembly illustrated in FIG. 3 has a compression set at 23 degrees Celsius that is generally between 15% and 35%, a compression set at 70 degrees Celsius that is generally between 23% and 43%, and a compression set at 100 degrees Celsius that is generally between 28% and 48% but preferably the compression set at 23 degrees Celsius is between 20% and 30%, the compression set at 70 degrees Celsius is between 28% and 38%, and the compression set at 100 degrees Celsius is between 33% and 43%. However, it should be apparent to one skilled in the art that materials having other compression set values could be used and the present invention is not limited to this expressed range of compression set values. A portion of the wiper arms 350, 352 or a portion of the wiper arms of the wiper seal 230 (and/or the side walls 382 and front face 384 of the bulb seal(s) 240, 250) of the sealing assembly illustrated in FIG. 3 are formed from a material having a compression set at 23 degrees Celsius of 25%, a compression set at 70 degrees Celsius of 33%, and a compression set at 100 degrees Celsius of 38%.

To achieve the desired stiffness, the mounting portion 346 and/or a portion of the wiper arms 350, 352 (and/or the mounting portion 370 and/or another portion of the bulb seal(s) 240, 250) of the sealing assembly illustrated in FIG. 3 are formed from a thermoplastic elastomer having a hardness (durometer), a tensile strength, and a modulus of elasticity. The thermoplastic elastomer used to form the mounting portion 346 and/or a portion of the wiper arms 350, 352 (and/or the mounting portion 370 and/or another portion of the bulb seal(s) 240, 250) of the sealing assembly illustrated in FIG. 3 has a hardness (durometer) that is generally between 45 Shore D and 65 Shore D but is preferably between 50 Shore D and 60 Shore D. However, it should be apparent to one skilled in the art that materials having other hardness (durometer) values could be used and the present invention is not limited to this expressed range of hardnesses (durometer). A portion of the mounting portion 346 and/or a portion of the wiper arms 350, 352 (and/or the mounting portion 370 and/or another portion of the bulb seal(s) 240, 250) of the sealing assembly illustrated in FIG. 3 are formed from a material having a hardness (durometer) of 55 Shore D.

The thermoplastic elastomer used to form the mounting portion 346 and/or a portion of the wiper arms 350, 352 (and/or the mounting portion 370 and/or another portion of the bulb seal(s) 240, 250) of the sealing assembly illustrated in FIG. 3 has a tensile strength that is generally between 2700 psi and 3900 psi but is preferably between 3000 psi and 3600 psi However, it should be apparent to one skilled in the art that materials having other tensile strength values could be used and the present invention is not limited to this expressed range of tensile strength. A portion of the mounting portion 346 and/or a portion of the wiper arms 350, 352 (and/or the mounting portion 370 and/or another portion of the bulb seal(s) 240, 250) of the sealing assembly illustrated in FIG. 3 are formed from a material having a tensile strength of 3300 psi.

The thermoplastic elastomer used to form the mounting portion 346 and/or a portion of the wiper arms 350, 352 (and/or the mounting portion 370 and/or another portion of the bulb seal(s) 240, 250) of the sealing assembly illustrated in FIG. 3 has a modulus of elasticity at 100% strain that is generally between 1700 psi and 2600 psi but is preferably between 1900 psi and 2300 psi However, it should be apparent to one skilled in the art that materials having other modulus of elasticity at 100% strain values could be used and the present invention is not limited to this expressed range of modulus of elasticity at 100% strain. A portion of the mounting portion 346 and/or a portion of the wiper arms 350, 352 (and/or the mounting portion 370 and/or another portion of the bulb seal(s) 240, 250) of the sealing assembly illustrated in FIG. 3 are formed from a material having a modulus of elasticity at 100% strain of 2100 psi.

The different sections of the wiper seal (s) 230 and/or bulb seal(s) 240, 250 which are made from different materials having different material properties can be formed separately using separate processes and subsequently joined together using an adhesive or other suitable method or the different sections of the wiper seal(s) 230 and/or bulb seal(s) 240, 250 could be formed together in one process, such as a two-part extrusion process. While various embodiments of the sealing assembly 100 include wiper seal(s) 230 and/or bulb seal(s) 240, 250 which include different sections which are formed from different materials having different material properties, it should be understood that the wiper seal(s) 230 and/or bulb seal(s) 240, 250 can also be formed from one material having uniform material properties. While various ranges of material properties are set forth above, it should be understood by those skilled in the art that the wiper seal(s) 230 and/or bulb seal(s) 240, 250 can be formed from a variety of different materials possessing a variety of different material properties and the sealing assembly 100 of the present application is not limited to the materials or the material properties set forth herein.

The sealing module 210 will now be described. As mentioned previously, the sealing module 210 shares several common components with the sealing module 200. If a component of the sealing module 210 is generally identical to a component of the sealing module 200, the component of the sealing module 210 will be given the same reference number as the corresponding component of the sealing module 200 along with a prime designation (′) in this detailed description as well as the Figures of this application. Components or features that are included with the sealing module 210 and not the sealing module 200 will be given their own unique reference number. It will be understood that additional embodiments of the sealing assembly 100 include sealing module 200 and sealing module 210 that do not share any common components.

The sealing module 210 includes a frame assembly 260. The frame assembly 260 can take a variety of shapes and configurations. Referring to FIG. 4, the frame assembly 260 of the illustrated embodiment of the sealing module 210 is of a modular construction and comprises a first frame member 300′, second frame member 302′, third frame member 400, and adjustable joint 306′.

In the embodiment of the sealing module 210 illustrated in FIG. 6, the sealing module is mounted to the bottom 118 of the opening 112 defined within the sidewall 110 of the recreational vehicle. Accordingly, the orientation of the components of the sealing module 210 are oriented differently (as shown in FIG. 6) than the corresponding components of the sealing module 200. Consequently, the entire description of the first frame member 300, second frame member 302, and adjustable joint 306 above, including description of structure, method of mounting and assembling, etc., is applicable to the first frame member 300′, second frame member 302′, and adjustable joint 306′ of the sealing module 210 with the understanding that the first frame member 300′, second frame member 302′, and adjustable joint 306′ of the sealing module 210 are oriented differently with respect to the side wall 110 than the corresponding components of the sealing module 200. It will be understood that the sealing module 200 and the sealing module 210 of additional embodiments of the sealing assembly 100 can be mounted to various portions of the recreational vehicle 120 or slide-out room 130 and may have different orientations in additional embodiments.

The sealing module 210 includes a third frame member 400. The third frame member 400 can take a wide variety of shapes and configurations. In the embodiment of the third frame member illustrated in FIG. 4, the third frame member 400 has a generally rectangular cross section when viewed from the side, i.e. as shown in FIG. 6. The third frame member 400 can have any shape or configuration that provides for the mounting of the third frame member 400 to the frame assembly 260 or another portion of the sealing module 210 and provides an attachment point for the mounting of additional components of the sealing module 210. As shown in FIG. 4, the illustrated embodiment of the third frame member 400 includes a wiper seal receiving channel 410. The wiper seal receiving channel 410 can take a variety of shapes and configurations. The wiper seal receiving channel 410 of the illustrated embodiment of the third frame member 400 is a slot defined within a portion of the top of the third frame member 400 (as illustrated in FIG. 6). The wiper seal receiving channel 410 can have any shape or configuration that provides for the receipt of a portion of the wiper seal 270. It will be understood that all embodiments of the sealing module 210 do not include a third frame member 400. In additional embodiments of the sealing module 210 the structure of the third frame member 400 is incorporated into the second frame member 302′.

In the embodiment of the sealing module 210 illustrated in FIG. 4, the second frame member 302′ includes a frame receiving recess 366′ for utilization as a platform in mounting the third frame member 400. The frame receiving recess 366′ of the second frame member 302′ can take a variety of shapes and configurations. In the embodiment of the second frame member illustrated in FIG. 5, the third frame member 400 is mounted to the second frame member 302′ by a plurality of fasteners 540′ that pass through a plurality of fastener openings (not shown) defined within the third frame member 400 and engage with the second frame member 302′. The fasteners 540′ of the embodiment of the sealing module 210 are conventional screws. It will be understood, however, that the third frame member 400 may be attached to the second frame member 302′ by any method now or hereafter known in the art. Examples of attachment methods include, but are not limited to, any type of screws, bolts, nails, rivets, welding, epoxy, glue, tape, cotter pins, rings, keys, tabs and slots, adhesives, and pressure fitting methods.

The sealing module 210 includes a wiper seal 270. The wiper seal 270 can take a wide variety of shapes and configurations. In the embodiment of the wiper seal 270 illustrated in FIG. 4, the wiper seal 270 comprises a mounting portion 420, and a wiper blade 422. The mounting portion 420 of the wiper seal 270 can take a variety of shapes and configurations. The mounting portion 420 of the embodiment of the wiper seal illustrated in FIG. 4 is a generally planar tab. The mounting portion 420 of the wiper seal 270 may have many other shapes in additional embodiments. For example, the mounting portion 420 may have a generally circular, triangular, square or other cross-sectional shape. The wiper seal 420 of the embodiment illustrated in FIG. 4 is formed out of a thermoplastic elastomer. Examples of additional materials that can be used for the wiper seal 270 include, but are not limited to, any type of natural or synthetic rubber, such as natural or synthetic polyisoprene, butadiene, ethylene-propylene-diene rubber, neoprene or blends thereof.

The embodiment of the wiper seal 270 illustrated in FIG. 4 has a generally planar shaped cross section when viewed from the side, i.e. as seen in FIG. 6, with the wiper blade 422 projecting from the mounting portion 420 of the wiper seal 270. Additional embodiments of the wiper seal 270 maybe shaped or configured differently. While the embodiment of the wiper seal 270 illustrated in FIG. 4 includes only one wiper blade 422, additional embodiments of the wiper seal 270 are not limited to one wiper blade and can include any number of wiper blades. Additional embodiments of the wiper seal 270 can include fins similar to the fins 354 of wiper seal 230 of the sealing module 200. In addition, it will be understood that the sealing module 210 may include a wiper blade similar to the wiper blade 230 of the sealing module 200 in place of, or in combination with, the wiper seal 270.

The embodiment of the wiper seal 270 illustrated in FIG. 4 is adapted to contact the bottoms wall 138 of the slide-out room 130 and remain in contact with the bottoms wall 138 whether the slide-out room 130 is stationary or moving relative to the side wall 110 of the recreational vehicle 130. The wiper seal 270 provides a resilient seal between the sealing module 210 and the slide-out room 130 when the slide-out room 130 is stationary with respect to the recreational vehicle 120. This resilient seal formed between the sealing module 210 and the slide-out room 130 helps to prevent air drafts, rain, snow, debris or other matter from entering the interior of the recreational vehicle through the interface between the recreational vehicle 120 and the slide-out room 130. The resilient seal formed by wiper blade 270 also helps to ensure that cool air or heated air that is intended to stay in the interior of the recreational vehicle does not escape through the interface between the recreational vehicle 120 and the slide-out room 130 as well. In addition, a portion of the wiper blade 270 could be coated with an optional material to increase its coefficient of friction. However, it should be understood that wiper blades of various embodiments of the sealing assembly are provided without any such coating.

As the slide-out room 130 is moved relative to the side wall 110 of the recreational vehicle, either inwardly or outwardly, the embodiment of the wiper seal 270 illustrated in FIG. 4 remains in contact with the bottom wall 138 of the slide-out room 130 and maintains a resilient seal between the sealing module 210 and the slide-out room 130. In addition to maintaining a resilient seal that prevents the entrance of air drafts, rain, snow, leaves, debris or other matter into the interior of the recreational vehicle 120 and prevents the escape of air from the interior of the recreational vehicle 120, the wiper seal 270 also serves to wipe away any excess water, leaves, insects, debris, or other matter that is located on the bottom wall 138 of the slide-out room 130 and prevent such matter from entering the interior of the recreational vehicle 120.

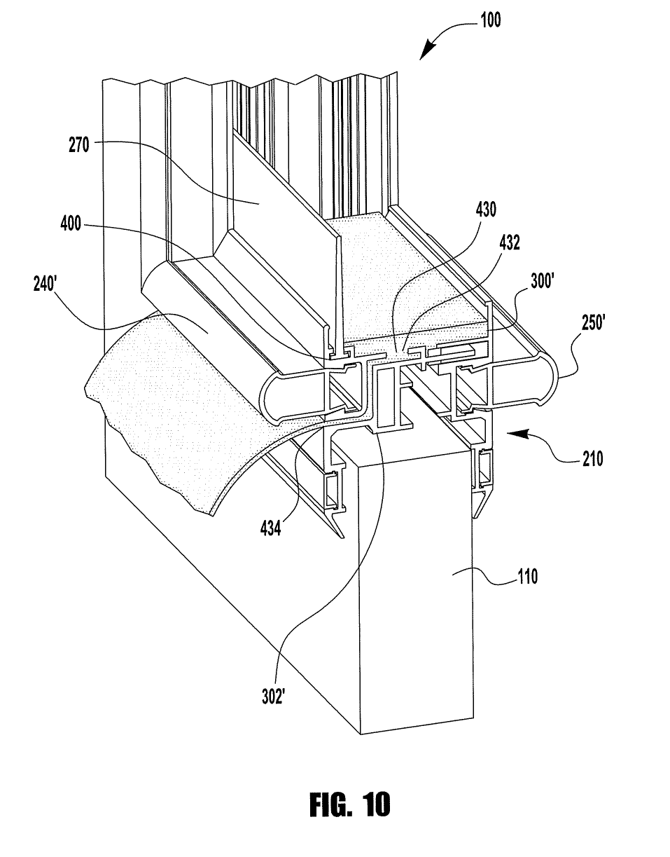

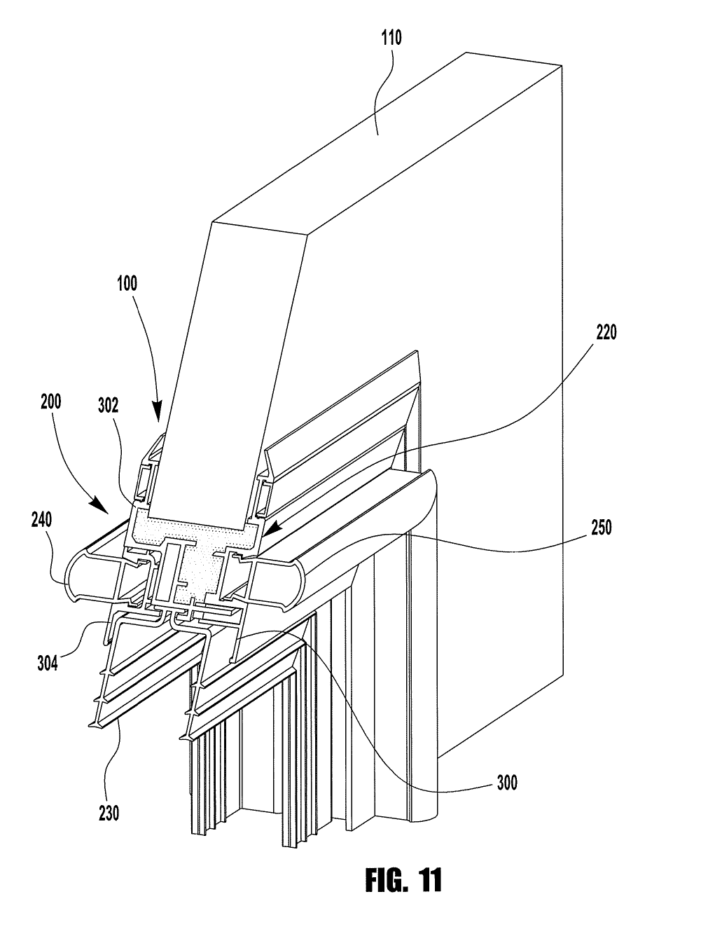

The frame assembly 260 of the sealing module 210 includes a drainage channel 430. The drainage channel 430 of the sealing module 210 can take a wide variety of shapes and configurations. In the embodiment of the frame assembly illustrated in FIG. 4, the drainage channel 430 is a gap that is defined between the second frame member 302′ and the third frame member 400 of the second sealing module 210 when the third frame member 400 is mounted to the second frame member 302′. In the embodiment of the frame assembly 260 illustrated in FIG. 4, the gap between the second frame member 302′ and third frame member 400 is formed by several spacers (not shown) that are mounted between the second frame member 302′ and third frame member 400 at intervals along the length of the frame assembly 260. However, it should be understood by those skilled in the art that this gap could be formed in different ways in additional embodiments of the sealing assembly 100. For example, this gap could be formed by the fasteners used or the frame members could be adapted to include integrally formed spacers, etc. The embodiment of the drainage channel 430 illustrated in FIG. 4 has an inlet 432 and an outlet 434. Water or other fluid that enters the sealing module 210 can enter the inlet 432 of drainage channel 420, pass through the drainage channel 420, and exit the sealing module 210 via the exit 434 of the drainage channel 420 (as illustrated in FIG. 10). The drainage channel 420 helps to ensure that any water or other fluid that enters the sealing module 210 does not enter the interior of the recreational vehicle 120, but rather is directed to the exterior of the recreational vehicle 120.

Additional embodiments of the sealing assembly 100 may include bulb seals 240, 250 which abut one another in mitered corners in the corners of the sealing assembly 100. This mitering of the corners helps to ensure an even and consistent seal around the perimeter of the slide out room and also helps to ensure that moisture does not enter the sealing assembly 100 through the area where the bulb seals 240, 250 abut one another. However, it should be understood that not all embodiments of the sealing assembly include bulb seals with mitered corners. In addition, the corners or other portions of the frame assemblies 220, 260 of the sealing assembly 100 may be injected with a foam or other material to further increase the water tight qualities of the sealing assembly. Such optional foam or other sealing material may be injected or otherwise inserted or applied to the frame assemblies 220, 260 or other portions of the sealing assembly once the sealing assembly has been assembled to fill any voids within a portion of the frame assembly and to help prevent any gaps which could permit moisture or other matter to enter the sealing assembly. Referring now to FIG. 11, a cutaway perspective view of a corner of the first sealing module 200 is shown with the frame assembly 220 filled with expandable foam. In addition, other sealants other than expandable foam, such as caulking or other various materials, can be used in additional embodiments of the sealing assembly to fill the frame assembly or to seal gaps in the frame assembly. However, it should be understood by those skilled in the art that additional embodiments of the sealing assembly 100 are provided without expandable foam or other such sealants.

The modular construction of the embodiment of the sealing assembly 100 illustrated in FIG. 2 allows the various parts and components (such as the wiper seal(s) 230, bulb seal(s) 240, 250, etc.) to be removed and/or replaced from the recreational vehicle 120 without removing the entire sealing assembly 100 from the recreational vehicle. This increases the ease with which the various parts and components of the sealing assembly to be installed, removed, serviced and/or replaced. Some embodiments of the sealing assembly 100 are installed by a purchaser, while other embodiments are installed during the assembly of the recreational vehicle at a factory location. The components of some embodiment of the sealing assembly 100 are constructed to be used with an opening 112 defined within a sidewall 110 that has predetermined dimensions. Additional embodiments of the sealing assembly 100 can be customized by the assembler to fit openings 110 having various dimensions by either cutting the components of the sealing assembly to a desired length or by piecing together multiple components of a determined length to obtain the desired length. Additionally, in some embodiments of the sealing assembly 100, attachment of the sealing assembly 100 is achieved in a removable fashion, while in other embodiments, attachment of the sealing assembly 100 is permanent.

It will be understood that the embodiments discussed above are representative of aspects of the invention and are provided as examples and not an exhaustive description of implementations of an aspect of the invention. While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated.

1. A wiper seal adapted for contacting a surface to create a resilient interface to facilitate the removal of water or debris from the surface when the wiper seal is moved across the surface, the wiper seal comprising:
at least one mounting portion; and
at least one flexible elongated wiper blade connected to the at least one mounting portion and having a length and a height, and first and second faces, wherein at least one of each face has at least one outwardly projecting fin that extends along at least a portion of the length of the wiper blade.

2. The wiper seal according to claim 1, wherein each of said at least one blades has on each of its faces two or more fins oriented in parallel relative to one another, and separated from one another by a distance along the height of the wiper blade.

3. The wiper seal according to claim 2 wherein the fins project from the wiper blade at a generally perpendicular orientation relative to the face.

4. The wiper seal according to claim 3 wherein the fins have a generally elongated triangular cross-sectional shape.

5. The wiper seal according to claim 2 wherein the spacing of the fins along the height of the first and second faces of the at least one wiper blade are the same.

6. The wiper seal according to claim 2 wherein the at least one wiper blade comprises two fins on each of its faces.

7. The wiper seal according to claim 1 comprising two wiper blades.

8. The wiper seal according to claim 7 wherein each wiper blade comprises at least two fins on each of its faces.

9. The wiper seal according to claim 7 wherein the wiper blades are formed in a U-shape projecting from the at least one mounting portion.

10. The wiper seal according to claim 1 wherein the wiper seal comprises a first mounting portion and a second mounting portion; and
a first wiper blade projecting from the first mounting portion and a second wiper blade projecting from the second mounting portion.

11. The wiper seal according to claim 1 wherein a first portion of the wiper seal is formed from a first material having a first hardness and a second portion of the wiper seal is formed from a second material having a second hardness.

12. A bulb seal comprising:
a mounting portion;
a pair of side walls extending from the mounting portion; and
an arcuate front face connected to the pair of side walls, the arcuate front face having a pair of shoulders on first and second sides of the front face and proximate to each of the side walls, respectively, wherein the shoulders extend outward beyond the side walls.

13. The bulb seal according to claim 12 wherein the mounting portion comprises a base wall and a pair of legs extending from the base wall.

14. The bulb seal according to claim 13 wherein the legs comprise a locking notch.

15. The bulb seal according to claim 12 wherein a first portion of the bulb seal is formed from a first material having a first hardness and a second portion of the bulb seal is formed from a second material having a second hardness.

16. The bulb seal according to claim 15 wherein the mounting portion of the bulb seal is formed from a first material having a first hardness and the side walls and front face of the bulb seal are formed from a second material having a second hardness.

17. The bulb seal according to claim 12 wherein the side walls and the front face have a generally equal thickness.

18. A sealing assembly for sealing the interface between a slide-out structure mounted to a base structure and adapted to move between a retracted position within the base structure and an extended position, comprising:
a frame adapted for attachment to a wall of either the slide-out structure or the base structure, the frame being adapted for attachment to walls having various length and width dimensions and being adapted to partially enclose a portion of the wall; and
at least one sealing component connectible to the frame and adapted to form a seal between the slide-out structure and the base structure.

19. The sealing assembly according to claim 18 wherein the frame comprises at least a first frame member and a second frame member; and wherein the frame further comprises an adjustable joint joining the first frame member and second frame member for adjusting the frame for mounting to walls having various dimensions.

20. The sealing assembly according to claim 19 wherein the adjustable joint comprises a slot defined within a portion of one of the first or second members and a tab protruding from a portion of the other of the first or second member, the slot being adapted to receive the tab.

21. The sealing assembly according to claim 20 wherein the adjustable joint further comprises a sealant for use in sealing the adjustable joint.

22. The sealing assembly according to claim 21 wherein the sealant is butyl rubber.

23. A sealing assembly for sealing the interface between a slide-out structure and a base structure, comprising:
a frame for mounting the sealing assembly to a wall of either the s1ide-out structure or the base structure; and
at least one wiper seal and at least one bulb seal mounted to the frame;
wherein the at least one wiper seal comprises at least one mounting portion and at least one flexible elongated wiper blade connected to the at least one mounting portion and having a length and a height, and first and second faces, wherein at least one of each face has at least one outwardly projecting fin that extends along at least a portion of the length of the wiper blade.

24. The sealing of assembly 23 wherein the slide-out structure is adapted to move between a retracted position within the base structure and an extended position, further comprising:
at least one bulb seal mounted to the frame for contact with a portion of the slide-out structure when the slide-out structure is in the retracted position; and
at least one bulb seal mounted to the frame for contact with a portion of the slide-out structure when the slide-out structure is in the extended position.

25. The sealing assembly according to claim 23 wherein each of said at least one wiper blades of the at least one wiper seal has on each of its faces two or more fins oriented in parallel relative to one another, and separated from one another by a distance along the height of the wiper blade.

26. The sealing assembly according to claim 25 wherein the fins project from the at least one wiper blade at a generally perpendicular orientation relative to the face.

27. The sealing assembly according to claim 26 wherein the fins have a generally elongated triangular cross-sectional shape.

28. The sealing assembly according to claim 25 wherein the spacing of the fins along the height of the first and second faces of the at least one wiper blade are the same.

29. The sealing assembly according to claim 25 wherein the at least one wiper blade comprises two fins on each of its faces.

30. The sealing assembly according to claim 23 wherein the at least one wiper blade comprises two wiper blades attached to the at least one mounting portion in parallel to one other.

31. The sealing assembly according to claim 30 wherein the scaling assembly comprises at least one wiper seal and wherein each of the at least one wiper blades comprises at least two fins on each of its faces.

32. The sealing assembly according to claim 23 wherein the at least one wiper seal comprises at least two wiper blades independently mounted to a first mounting portion and a second mounting portion, and wherein the first mounting portion and the second mounting portion are mounted to the frame independently.

33. The sealing assembly according to claim 23 wherein a first portion of the at least one wiper seal is formed from a first material having a first hardness and a second portion of the wiper seal is formed from a second material having a second hardness.

34. The sealing assembly according to claim 23 wherein the mounting portion of the at least one bulb seal comprises a base wall and a pair of legs extending from the base wall; and wherein the frame further comprises at least one recess for receiving the mounting portion of the bulb seal.

35. The sealing assembly according to claim 34 wherein the legs of the at least one bulb seal comprise a locking notch; and wherein the locking notch of the legs of the bulb seal engage with a portion of the frame.

36. The sealing assembly according to claim 23 wherein the mounting portion of the at least one bulb seal is formed from a first material having a first hardness and the side walls and front face of the bulb seal are formed from a second material having a second hardness.

37. The sealing assembly according to claim 23 wherein the frame is adapted for attachment to walls having various length and width dimensions and being adapted to partially enclose a portion of the wall.

38. The sealing assembly according to claim 37 wherein the frame comprises at least a first frame member and a second frame member; and wherein the frame further comprises an adjustable joint joining the first frame member and second frame member for adjusting the frame for mounting to walls having various dimensions.

39. The sealing assembly according to claim 38 wherein the adjustable joint comprises a slot defined within a portion of one of the first or second members and a tab protruding from a portion of the other of the first or second member, the slot being adapted to receive the tab.

40. The sealing assembly according to claim 39 wherein the adjustable joint further comprises a sealant or use in sealing the adjustable joint.

41. The sealing assembly according to claim 40 wherein the sealant is butyl rubber.

42. The sealing assembly according to claim 23 wherein the frame comprises a channel for permitting the passage of water or other fluid through the frame whereby the channel serves to capture water and flush the water from the interior of the frame.

43. The sealing assembly according to claim 23 wherein the slide-out structure is adapted to move between a retracted position within the base structure and an extended position comprising:
at least one wiper seal mounted to the frame;
at least one bulb seal mounted to the frame for contact with a portion of the slide-out structure when the slide-out structure is in the retracted position;
at least one bulb seal mounted to the frame for contact with a portion of the slide-out structure when the slide-out structure is in the extended position; and
wherein the frame comprises at least a first frame member and a second frame member; and wherein the frame further comprises an adjustable joint joining the first frame member and second frame member for adjusting the frame for mounting to walls having various dimensions whereby the at least one wiper seal serves as the primary weather seal and the at least one bulb seal serves as the secondary seal when the slide-out structure is in the extended position.

44. The sealing assembly according to claim 23 wherein the slide-out structure is adapted to move between a retracted position within the base structure and an extended position further comprising at least a first sealing module and a second sealing module;
wherein the first sealing module comprises:
a frame for mounting the first sealing module to a wall of either the slide-out structure or the base structure;
at least one wiper seal mounted to the frame of the first sealing module, the at least one wiper seal comprising a mounting portion and at least one flexible elongated wiper blade connected to the mounting portion and having a length and a height, and first and second faces, wherein at least one of each face has at least one outwardly projecting fin that extends along at least a portion of the length of the wiper blade;
at least one bulb seal mounted to the frame of the first sealing module for contact with a portion of the slide-out structure when the slide-out structure is in the retracted position; and
at least one bulb seal mounted to the frame of the first sealing module for contact with a portion of the slide-out structure when the slide-out structure is in the extended position; and
wherein the second sealing module comprises:
a frame for mounting the second sealing module to a wall of either the slide-out structure or the base structure;
at least one wiper seal mounted to the frame of the second sealing module, wherein the wiper seal comprises a mounting portion and at least one flexible elongated wiper blade connected to the mounting portion and having a length and a height;
at least one bulb seal mounted to the frame of the first sealing module for contact with a portion of the slide-out structure when the slide-out structure is in the retracted position; and
at least one bulb seal mounted to the frame of the first sealing module for contact with a portion of the slide-out structure when the slide-out structure is in the extended position.
